(19) United States
(12) Patent Application Publication
(10) Pub. No.: US 2012/0290316 A1
(43) Pub. Date: Nov. 15, 2012

(54) Method and System for Consumer Centred Care Management

(75) Inventor: Gil Tidhar, Glen Iris (AU)

(73) Assignee: NEW IDEAS COMPANY PTY LTD, Glen Iris (AU)

(21) Appl. No.: 13/512,035

(22) PCT Filed: Feb. 19, 2010
(86) PCT No.: PCT/AU2010/000184

§ 371 Date: May 25, 2012

(30) Foreign Application Priority Data
Nov. 27, 2009 (AU) 2009905805

(51) Int. Cl. G06Q 50/22

(52) U.S. Cl. 705/2

(57) ABSTRACT

The present invention relates to self care and care management. In one form, the invention provides a method for self-managed consumer centred cooperative care including the steps of: (a) the consumer registering their characteristics, (b) creating at least one cooperative care plan for addressing at least one of the needs and objectives of the consumer, (c) creating at least one action for the at last one cooperative care plan, (d) the consumer registering information for one or more other participants having roles chosen from the group including at least one of, (i) care providers, (ii) associates of the consumer, (iii) co-carer, (iv) primary care manager, (v) cooperative care plan manager, or combinations thereof, (e) the consumer, the primary care manager appointed by the consumer, or the cooperative care plan manager appointed by the consumer or the primary care manager, allocating at least one of the actions to one or more respective participants for implementation of the cooperative care plan, and (f) the consumer or the primary care manager appointed by the consumer, assigning permissions to the participants based on their role and any allocated actions, wherein steps (a) to (f) are automated.

### FIELD OF INVENTION

The present invention relates to the field of self care and care management.

In one form, the invention relates to the self management and coordination of care for people with special care needs.

In one particular aspect the present invention is suitable for use as a decentralised system for self-management of needs based care.

While the present invention is described with reference to the long term self care of persons in need it will be appreciated that the invention is not so limited but is applicable to decentralised management of needs based care for any necessary period of time that may be utilized by and delivered to members of the community regardless of their status, including age etc. Furthermore, while the present invention is described with reference to management of non-medical care, the present invention is not so limited and can be applied to other types of care exclusively, and also to medical care.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Many people across all age groups have special care needs. These include domestic, mobility, health, psychological, emotional, physical, social care needs and a range of others. Depending on circumstances, these people may have both immediate care needs, and needs that require them to work towards longer term preventative or maintenance goals. These include losing weight, changing diet, improving fitness, improving memory, improving behaviour etcetera.

### Facility Based Care

Compared to home based care, a large proportion of people with special needs, particularly long term needs, have had most of their care services managed and provided by institutions with specialised facilities, such as aged care facilities, social clubs, hospitals, care centres, rehabilitation centres, nursing homes, residential and day care facilities. This is often referred to as ‘facility based care’. Facility based care is usually managed and provided by experts who have an ongoing relationship with the institutions and typically co-located with the people for whom they provide care.

The management of facility based care has typically been the responsibility of expert care providers such as a social worker, medical administrator, doctor(s) and other clinical staff. These experts have had administrative procedures and supporting technology to assist them in the management and coordination of the care provided to a person in need. The procedures and technology have typically focussed on centralised management, by an expert manager, of professionals caring for a number of people in need.

### Home Based Care

In addition to facility based care, a number of people with special needs have relied on purely home based care, usually with a care professional such as nurse, social worker, medical practitioner, or physiotherapist having exclusive control over the provision of care.

These arrangements typically rely on a close family member to provide the care under'the direction of a care professional. In these situations the carer often suffers stress over the long term and the person in need is left vulnerable if the carer becomes unwell, can no longer provide care, or requires care themself. Ultimately facility based care may be required to replace the home based care.

Needs of People receiving Home Based Care

People receiving care at home require assistance in a range of areas including property maintenance, transport, housework, mobility, meal preparation, health care, and Other areas. Such assistance may be provided by a range of carers—predominantly family and friends. The majority of the carers are non health care professionals. Addressing these needs with quality care requires a coordinated approach and the coordination of carers. Furthermore, people in need often have the desire, capability and expectation to self-manage their care. There is therefore a need for a means for them to control the way care is provided to them and control what, and to whom, information about them is shared.

### Cooperative Self-Managed Home Based Care

Recently there has been a growing trend to move from primarily facility or home based care provision to a combination of community and home based care of a person in need.

The latter is typically provided by a combined group of independent volunteers and professional carers. Responsibility for the management and coordination of the care lies principally with the consumer, that is, the person in need and/or their family members, referred to as the ‘Primary Carer’.

The shift to this self-managed combination of community and home based care has affected large numbers of people in need of care and has introduced new problems and challenges for care coordination and management. For example, it requires empowerment of the person in need and their primary carers as to the making and effecting of care decisions and it requires a cooperative approach to delivery of care at home, which may be coined as ‘self-managed consumer centred cooperative home based care’.

The self-management and coordination of consumer centred cooperative home based care includes the person in need, with support from carers: identifying the needs and goals of the person in need, creating multiple approaches to addressing the, identified needs and goals, identifying and engaging multiple independent carers, and then ensuring that the requisite care is delivered in a coordinated manner. This may include the sharing of information between the carers.

There is also a need to share information about the care provided with friends or family members who are not necessarily directly or actively involved in provision of the care.

In these circumstances the management and coordination of self-managed consumer centred cooperative home based care may be performed by a ‘care manager’ or ‘care coordinator’ and requires a high degree of labour intensive organisation and administration. This is a significant change from purely home based care of the past which focused only on health care and which was almost exclusively managed by a health care professional.

Given the broad needs of the consumers, currently some aspects of the cooperative care manager's role may be performed by a representative from a government agency or by a medical practitioner. They may use automated systems available to them only to record fragments of information helpful to them regarding the patient, their needs and recommended care. Often these automated systems are commonly available but are in the form of non-specific or general purpose software/database packages such as Excel or Word. However, the management and control of care still remains outside the hands of the person in need preventing them from self-managing the care.

The use of manual systems or non-specific commercial software packages has the advantage of a very low barrier for usage, however it suffers from the myriad problems arising from lack of dedicated automation. These include difficulties in transferring, accessing and sharing information; duplication of information recordal; unreliable recordal of information and other quality control issues.

In the past, efforts have been made to automate aspects of management of home based health care as delivered by health care professionals. Although in these cases the health consumer (i.e., the person in need of health care) might have some ineffectual administrative role, the control and management of the health care is principally left in the hands of health care professional that coordinate and manage the care. These methods and systems are considered ‘health care professional centred’ and are designed from the point of view of access and use by this group of people. This includes systems for the management and coordination, of health care organizations and personnel. Accordingly, the accepted paradigm for the provision and management of care is one in which the focus is exclusively on health related care and the consumer plays a passive role when it comes to the control and/or management of the provision of care.

For example, WO 2008/061318 and CA 2653432 describe systems with automated support for a health professional in the generation of a health care plan for a person in need, collection of their health status information and generation of alerts to one or more health care providers regarding compliance with the health care plan. These systems are principally designed to support health care professionals.

WO 2007/066248 relates to a personalised health care plan, including educational content material, multiple revisions of the content, and a schedule for presentation of specified revisions to the person in need of care. Individual care plans can be stored and disseminated across a computer interface. This method of care is designed from the point of view of health care professionals and Is oriented to supporting their roles.

WO 2003/054668 relates to an internet-based system for management of appointments for health care professionals including a facility to store and retrieve information regarding the patients for whom the appointments were made. This type of system is principally oriented to the support of health care professionals.

US patent application, publication No 2008/183496 relates to a coordinated, collaborative approach between two or more health care professionals to the development of a patient heath care plan at the time of the patient's admission to a health care facility. The approach is designed to support interaction and coordination between health care professionals.

WO 2004/102457 relates to a healthcare provider management system for the management, scheduling, and coordination of health care workers providing health care to patients. It provides utilities for health personnel management, in so far as it facilitates matching of the credentials of health care workers assigned to a health care role with the qualification requirements of that role. It is designed for the health clinicians and health organization with a patient being able to confirm the appointment of a health care worker. Accordingly the system is designed to support health care professionals in the performance of their roles.

US 2009/0265185 relates to a patient information storage and retrieval system that is used by health care providers to store, retrieve, share and exchange patient health care records. The system automates the manual storage and sharing of patient health records. The system also allows for the assignment of priority of care to different patients and patient population. The system does not provide the patient with access to the system and thus it is principally exists to support health care professionals.

US 2009/089097 relates to the facilitation of real-time online delivery of consultation services (termed ‘e-Visits’) by health care consultants, or specialists, to patients. It allows the patient to identify, through an online directory, the health care specialist that can provide them with the consultation or health care information. Access to patient health records is also available and a care plan can be automatically generated during the e-Visit (in a manner similar to that disclosed and taught in WO 2008/061318 and CA 2653432 described above). The system is designed for the use of patients and specialists.

US 2008/0114613 relates to the storage and management of health insurance member data. The system further supports the assessment of member risk profile and the selection of health insurance plan. The system also allows for the health insurance professional to create a plan for the monitoring and care of the member. The system is designed to support health insurance professionals.

Demographics indicate that lifespan in developed nations, is increasing. This is in part due td improvements in medicine, particularly improvements in treatment of long-term or chronic illnesses. Accordingly, there is an increasing pressure on care and support organizations, including healthcare, to provide long term needs based care. Furthermore, people in need often have a level of education, independence, and an attitude that leads to an expectation that they should be able to self-manage and control their care, coordinate carers, and control of the sharing of information about their care.

This has led to a need for the person in need to become the main user of care management systems, in contradistinction to the care management systems of the past that focussed on health care and the health care professionals being the main user.

A number of key people (the person in need of care, cooperative care manager, health care professionals, carers, friends and, family members) may operate independently and be widely geographically separated. Accordingly, coordination and self-management of consumer centred cooperative home based care is much more complex than facility based care or purely home based health care, exclusively controlled by a health care practitioner and limited to health needs. There is therefore a need for a method and system that permits the consumer (i.e., the person in need) to self-manage their care and for their large group of cooperative carers to efficiently formalise and document, as directed by the consumer, the care relationships, networks and plans that support consumer centred cooperative care both within the home and the community. There is also a need for the consumer and the cooperative carers to be able to learn from others and share experiences.

### SUMMARY

It would be desirable to provide for a consumer (i.e., person in need) to self-manage their care including the coordination of a group of cooperative carers for home and/or community based care.

An object of the present invention is to provide a care management system and method that focuses on all aspects of care and on the person in need of care as a user or consumer, as an alternative to the health care management systems of the prior art which focus on health care and on health care providers as users or consumers.

An object of the present invention is to alleviate at least one disadvantage associated with the related art.

It is also an object of the embodiments described herein to overcome or alleviate at least one of the above noted drawbacks of related art systems or to at least provide a useful alternative to related art systems.

In a first aspect of embodiments described herein there is provided a method for self-managed consumer centred cooperative care comprising the steps of:
(a) the consumer registering their characteristics,
(b) creating at least one cooperative care plan for addressing at least one of the needs and objectives of the consumer,
(c) creating at least one action for the at least one cooperative care plan,
(d) the consumer registering information for one or more other participants having roles chosen from the group comprising at least one of,
   (i) care providers,
   (ii) associates of the consumer,
   (iii) co-carer,
   (iv) primary care manager,
   (v) cooperative care plan manager,
or combinations thereof,
(e) the consumer, primary care manager appointed by the consumer, or the cooperative care plan manager appointed by the consumer or primary care manager, allocating at least one of the actions to one or more respective participants for implementation of the cooperative care plan, and
(f) the consumer or the primary care manager appointed by the consumer, assigning permissions to the participants based on their role and any allocated actions,
wherein steps (a) to (f) are automated.

In preferred embodiments the role of cooperative care plan manager is to coordinate the development and implementation of the cooperative care plan and to ensure that all actions and activities relating to the cooperative care plan are carried out.

The embodiments of the present invention provide for self-managed consumer centred cooperative care that may be home based or otherwise community based, which may include care provided for the consumer at a facility which can take care of their needs. Where used herein the term ‘home based care’ is used broadly to include not only the usual residence of a consumer, being person in need, but any place they are usually located that is not a facility.

In a preferred embodiment the registered characteristics associated with the consumer as a person in need, are chosen from the group comprising needs, goals and combinations thereof. Their cooperative care plan may be created uniquely for their needs, by one or more participants with permissions assigned by the consumer, including the consumer themself. Alternatively, the cooperative care plan may be imported as a template. The template could be imported from the records of another person in need, thus drawing on the experience of another group of people involved in cooperative home based care.

The care providers include anyone who can provide a service in response to a need or goal. Such services might be as a friend or volunteer or on commercial basis. These services may include other service providers such as for example, plumbers, domestic cleaners, chauffers and taxi drivers, legal advisors, financial advisors, Insurance advisors, trustees, those holding a power of attorney or other relevant instrument, or a person appointed by a court or administrative body. These services may also include those of health care service providers. Their services may relate for example, to making decisions regarding treatment of the consumer as a person in need, based on medical power of attorney or their financial capabilities under an award of damages or within the limits of a pension or other income. It is envisaged that in one embodiment of the present invention the care provider may take the form of an appointed member of the police providing services in relation to detention orders, for example.

The associates include anyone having an interest in the consumer as a person in need, but who does not necessarily provide a service. This group could include, for example, friends or relatives.

In a preferred embodiment the permissions assigned relate to access to and modification of needs and care information and ability to information share and communicate with other participants or ability to create cooperative care plans or to be involved in the actions comprised in the cooperative care plans. The permissions relating to communication can be used to facilitate the formation of networks between participants having a point of commonality such as their role (e.g. care provider, associate, co-carer, primary care manager), a common action, or to fulfil a need or desire for information.

In a preferred embodiment, the method also includes the step of the consumer designating one or more persons to the role of primary care managers to manage and coordinate the overall care provided to the consumer as a person in need, on their behalf. The primary care managers may be drawn from the care providers, associates or the consumer themself.

In a preferred embodiment, the method also includes the step of the consumer or a designated primary care manager designating one or more persons to the role of cooperative care plan managers to coordinate the development and implementation of the cooperative care plan and to ensure that all actions and activities relating to the cooperative care plan are carried out. The cooperative care plan managers may be drawn from the care providers or the consumer themself.

In another preferred embodiment, each action may have allocated to it a person in the role of primary carer and optionally one or more co-carers. This person or group of people have direct responsibility for ensuring that an action is carried out, The primary carer may be drawn from the care providers, associates or the consumer themself.

In a second aspect of embodiments described herein there is provided a method for self-managed consumer centred cooperative care including at least one participant, the method comprising the steps of;
(a) the consumer registering their characteristics,
(a)(i) the consumer designating at least one of the participants to the role of primary care manager,
(b) the consumer or primary care manager creating at least one cooperative care plan designed to address at least one need or objective of a participating consumer,
(b)(i) the consumer or primary care manager designating at least one of the participants to the role of cooperative care plan manager,
(c) the consumer, primary care manager, or cooperative care plan manager creating at least one action for one or more of the cooperative care plans,
(d) one or more other participants registering information and having roles chosen from the group comprising,
   (i) care providers,
   (ii) associates of the consumer,
   (iii) co-carer,
   (iv) primary care manager,
   (v) cooperative care plan manager,
or combinations thereof,
(e) the consumer, primary care manager, or cooperative care plan manager allocating at least one of the actions to one or more respective participants for implementation of the cooperative care plan,
(e)(i) the consumer, primary care manager, or cooperative care plan manager for each action, designating one or more participants to a role chosen from the group comprising primary care providers or co-carer, and
(f) the consumer or primary care manager assigning permissions to the consumer and to the participants based on their role and any allocated actions,
wherein steps (a) to (f) are automated.

In a preferred embodiment the registered characteristics associated with the consumer are chosen from the group comprising the person's needs, objectives, goals and combinations thereof.

The above described method may further include provision for sharing and learning from experiences relating to the cooperative care plan of different persons in need who comprise consumers. That is the method of this preferred embodiment of the present invention may include a step of exporting or importing information relating to the cooperative care plan to or from a database of another consumer.

In a third aspect of embodiments described herein there is provided a computer implemented system for consumer centred cooperative care comprising;
(a) first registration means for registering characteristics associated with a consumer in a first database,
(b) first automated creation means for creating at least one or more cooperative care plans designed to address one or more of the needs and objectives of the consumer,
(c) second automated creation means for creating one or more actions for one or more of the cooperative care plans,
(d) second registration means for registering information in a second database for one or more other participants having roles chosen from the group comprising,
   (i) care providers,
   (ii) associates of the consumer,
   (iii) co-carer,
   (iv) primary care manager, (
   v) cooperative care plan manager,
or combinations thereof,
(e) allocation means for allocating at least one of the actions to one or more respective participants for implementation of the cooperative care plan, and
(f) assigning means for assigning permissions to the consumer and to the other participants based on their role and any allocated actions,
(g) messaging means for sending notifications and requests between participants,
   wherein steps (a) to (g) are automated.

The messaging means may include an internal messaging means implemented using the databases and user interfaces of the automated system and external messaging means implemented using external email system, SMS systems for mobile phones, short messages implemented using pager systems, etc.

A suitable platform for the above described system for self-managed cooperative care would comprise one or a combination of a personal computer (be it desktop or laptop), a server, a terminal connected to a server, or a hand held mobile device, or a Personal Digital Assistant, connected via a communication network to one or more other computers and database servers.

The first database and second database of the above system may be the same or different databases. The registered characteristics may include at least one or more needs, goals or objectives of the consumer.

Typically the first database holding records for the participating person, for example a consumer being a patient in need, is located on a central server. The second database holding records for the participants may be located on the same, or a different central server. The central server may be located at a main IT server facility, a facility such as a hospice, hospital or other care facility or at any other convenient location. It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

In a fourth aspect of embodiments described herein there is provided an apparatus adapted to automate consumer centred cooperative care said apparatus comprising:
processor means adapted to operate in accordance with a predetermined instruction set,
said apparatus, in conjunction with said instruction set, being adapted to perform the above described methods as disclosed herein in any combination of the method steps (a) to (g) described above.

In a fifth aspect of embodiments described herein there is provided a system for consumer centred cooperative care, the system comprising;
(A) a central server, and
(B) one or more remote terminals,
   wherein the server
(a) receives characteristics for a participating consumer for registration in a database record including one or more cooperative care plans comprising one or more actions,
(b) receives information for registration in a database record for one or more participants having roles chosen from the group comprising,
   (i) care provider,
   (ii) associates of the consumer,
   (iii) co-carer,
   (iv) primary care manager,
   (v) cooperative care plan manager,
or combinations thereof,
(c) receives information regarding allocation of one or more participants to the role of primary care manager for a consumer,
(d) receives information regarding the allocation of one or more participants to the role of cooperative care plan manager for a cooperative care plan,
(e) receives information regarding allocation of one or more actions to one or more respective participants for implementation of the cooperative care plan, and
(f) receives information regarding assignment of permissions to the consumer and to the other participants based on their roles and any allocated actions.

The system may additionally comprise:
(AA) a local distribution server, wherein the local distribution server,
(i) performs identical functions to the central server for records pertaining to one or more persons in need, and
(ii) forwards records for a consumer or participants to the central server.

In yet a sixth aspect of embodiments described herein there is provided a computer readable recording medium having computer readable program code and computer readable system code embodied on said computer readable recording medium, for monitoring consumer centred cooperative care within a data processing system,
wherein said computer readable program code and said computer readable system code are adapted for carrying out any combination of the above described method steps (a) to (f) as disclosed herein within a data processing system.

In yet a seventh aspect of embodiments described herein there is provided a system for monitoring care, the system comprising;
(a) at least one remote terminal adapted for communicating characteristics for a participating consumer including one or more cooperative care plans comprising one or more actions, for recordal in a first database,
(b) at least one remote terminal adapted for communicating information for one or more participants having roles chosen from the group comprising,
   (i) care providers,
   (ii) associates of the consumer,
   (iii) co-carer,
   (iv) primary care manager,
   (v) cooperative care plan manager,
      or combinations thereof, for recordal in a second database,
(c) at least one remote terminal adapted for communicating instructions for allocation of roles to participants as primary care managers,
(d) at least One remote terminal adapted for communicating instructions for allocation of roles to participants as cooperative care plan managers,
(e) at least one remote terminal adapted for communicating instructions for allocation of the actions for implementation ‘of the cooperative’ care plan by one or more participants,
(f) at least one remote terminal adapted for communicating instructions for assignment of permissions to the consumer and to the other participants based on their roles and any allocated actions.

In a further embodiment the present invention provides a server when used for the communications described in the above described seventh aspect of embodiments of the invention.

Other aspects and preferred forms are disclosed In the specification and/or defined in the appended claims, forming a part of the description of the invention.

In essence, embodiments of the present invention stem from the realization that cooperative care requires a cooperative approach across a group of disparate people with disparate skill sets often as well as the consumer as a person in need of care, and that certain applications of, information technology can provide both individual autonomy and independence when required, and networking and sharing of information when required to deliver care efficaciously. Effectively, the consumer of care becomes an active participant when it comes to the control and/or management of the provision of care. In contrast to known systems, the present embodiments of the invention introduce a new paradigm in the provision of care where the consumer becomes an integral element in the care provision system as opposed to being a passive recipient of the outputs of the care scheme.

Advantages provided by the present invention comprise the following:
Flexibility to cover all aspects of needs based care, beyond just health care,
It empowers the consumer, being a person in need of care, and all those involved in cooperatively providing their care to efficiently coordinate and manage their participation,
It allows participants to form one or more support networks,
It provides a means to share information and experiences relating to the implementation and performance of cooperative care actions

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates four principal, levels of responsibility allocated to participants of a self-managed consumer centred cooperative home based care process in accordance with a preferred embodiment of the present invention;

FIG. 2 illustrates through an example the conceptual structure of self-managed consumer centred cooperative care management in accordance with a preferred embodiment of the present invention with circles of care structured around the consumer involved in self-management and along cooperative care plan and cooperative care actions (with carers filling multiple roles);

FIG. 3 illustrates through an example the implementation architecture for self-managed consumer centred cooperative care management in accordance with a preferred embodiment of the present invention;

FIG. 4 is a schematic diagram which illustrates the internal components of a server supporting self-managed consumer centred cooperative care management in accordance with a preferred embodiment of the present invention;

FIG. 5 is a flow chart which illustrates an exemplary processing of a self-managed consumer centred cooperative care management system in accordance with a preferred embodiment of the present invention.

### DETAILED DESCRIPTION

In accordance with a preferred embodiment, each person involved in the self-managed consumer centred cooperative home based care is a participant having at least one role, which may change over time. The method and system of preferred embodiments of the present invention, inter alia, facilitate the establishment of relationships between participants and the assuming of responsibilities and actions necessary for the self-managed care and cooperative provision of care.

In a preferred embodiment the system for self-managed cooperative home based care includes the following components, some of which may not be populated with data:
1. a dataset for the participating consumer; this dataset includes contact details, a set of needs, objectives and/or goals to be addressed, cooperative care plans including actions addressing the needs, objectives and/or goals, and status information as provided by the consumer,
2. a dataset for the other participants; this dataset includes contact details, a set of services they can provide opposite needs, objectives and/or goals,
3. a dataset of previously defined needs, objectives and/or goals,
4. a dataset of friendship and care relationship links between participants,
5. a dataset of primary care relationship links between participants,
6. a dataset of cooperative care plans for each participant,
7. a dataset of actions for each cooperative care plan,
8. a dataset of previously defined action types,
9. a dataset of rules allocating participants to respective actions,
10. a dataset of information sharing and management protocols and permissions between participants and their allocated actions,
11. a dataset of notifications and requests for each participant where a ‘notification’ is one directional information provided from one participant to another and a ‘request’ from one participant to another requires a response from the requested participant,
12. a dataset of experiences and reviews of care and care providers,
13. search tools for finding participants and reviews and viewers for viewing information about participants,
14. viewers and editors for the dataset for the participant,
15. viewers and editors for the cooperative care plans,
16. viewers and editors for the actions,
17. tools for establishing and viewing the friendship and care relationships,
18. tools for viewing and managing permissions,
19. viewers, editors, tools, and utilities for showing notifications and requests and responding to such requests,
20. tools for searching and viewing results of searching the dataset of participants and the datasets of care relationships,
21. internal and external messaging utilities for creating, exchanging and displaying, notifications and requests, including a utility for responding to requests,
22. tools and utilities that support the viewing, management, and manipulation of the datasets at items 1 to 12 above;
23. user interfaces that support the usage of and interaction with the components in items 13 to 22. Such user interfaces can be implemented as a computer application running on a personal computer or terminal, a mobile or smart phone application running on a mobile or smart phone device, a web based service, website, or a web based application accessed through a web browser or as an add-in to a web browser, or a combination thereof.

In the context of this description of the preferred embodiment, a search tool may include a user interface and search code that allows a user to search through specific datasets in the database and retrieve records that match the search criteria. An example of a search tool for participants is described below in Functionality 5: Searching for Participants. A viewer for a dataset, in the context of this description, may include a user interface and code for retrieving a specified record that allows the user to view a specified record in the dataset. An example of a viewer for actions is a user interface that displays the attributes of an action as described below in Functionality 8.4.2: Adding an Action. An editor for a dataset, in the context of this description, may include a user interface and code for retrieving a specified record from the dataset, displaying the attributes of the record, amending the record attributes based on user input, and storing the amended record (and any dependant records) in the dataset, that allows the user to create and amend records in the dataset. An example of an editor for consumer centred cooperative care plans in accordance with preferred embodiments is described below in Functionality 8. An internal messaging means includes a user interface for displaying notifications and requests and code for creating a record of notification or request based on user input, storing the notification or request in the dataset of notifications and requests, retrieving the list of notifications and requests for a specific user from the dataset of notification and requests, and displaying the list of notifications and requests. The internal messaging utility includes a utility for responding to requests. Examples of a messaging utility and a utility for responding to requests are described below in Functionality 8.

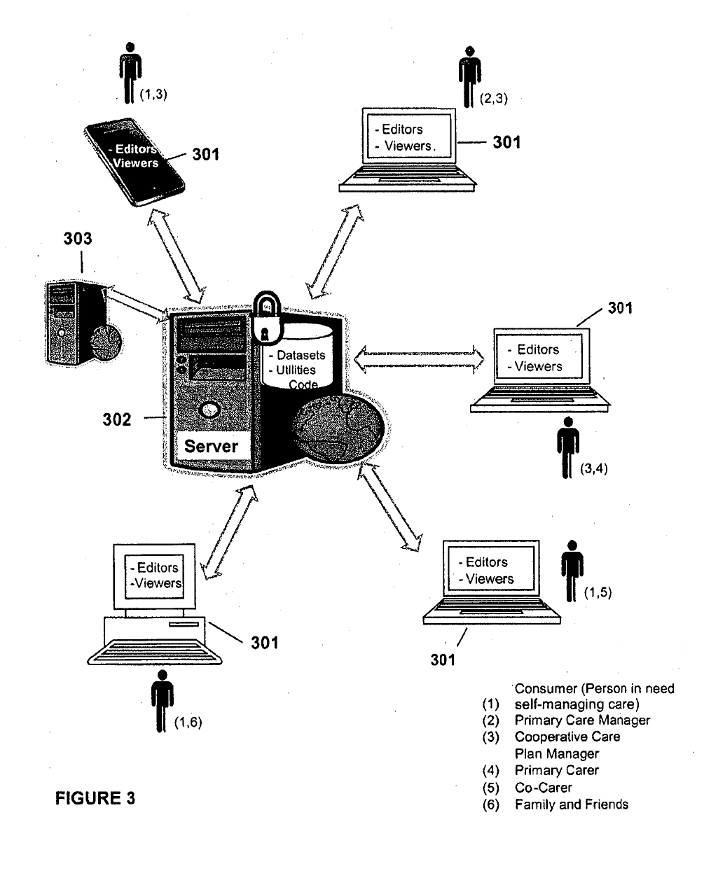

In further detail, FIG. 3 illustrates example implementation architecture for consumer centred cooperative care management in accordance with the preferred embodiment of the present invention. In particular, user interfaces 301, including viewers and editors, may be embodied on laptops, PCs and smart phone devices. In this example the datasets and code servicing the viewers and editors are implemented on one or more servers 302 and 303 but it is envisaged that such datasets and code may equally be implemented in a decentralised fashion where they may reside or be updated at the endpoints 301. Furthermore, it is envisaged that combinations or hybrids of such implementation could be adopted. The users of the self-managed consumer centred cooperative care management system adopt multiple roles, shown as (1) to (6) in FIG. 3, as they can participate in multiple relationships and in some cases care for someone while at the same time receiving support.

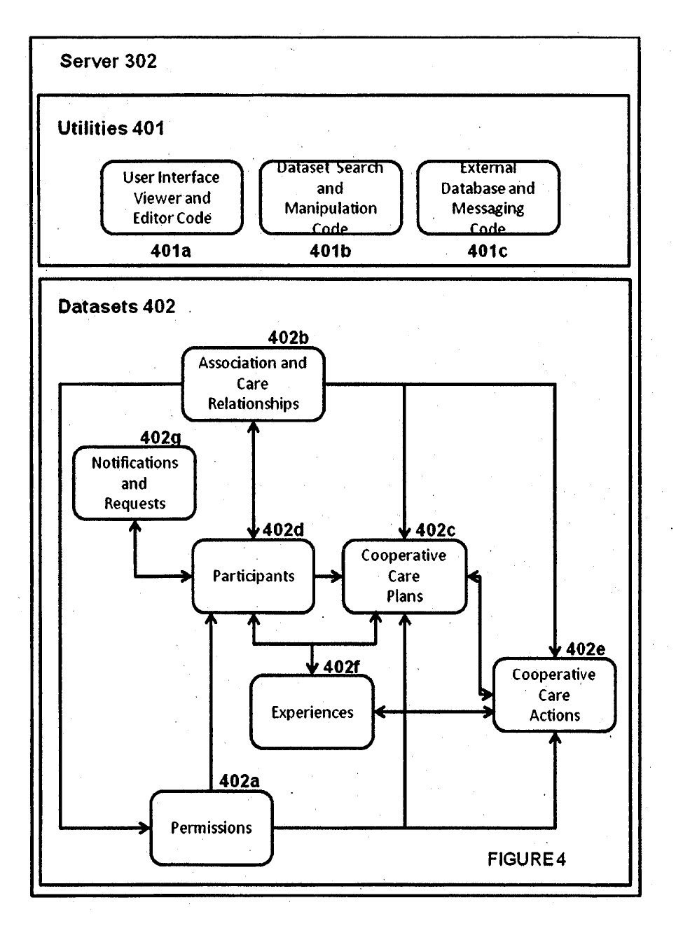

The components on the server 302 and their interactions are illustrated in FIG. 4. A preferred method of Implementation of this architecture is as a web based service where the server 302 is a web server running web applications and relational databases and the viewers and editors 301 are implemented using web browser technology. As Illustrated in the schematic of FIG. 4 there are two types of components, namely utilities 401 and the datasets 402 that store the participants, care, and relationship information. The utilities comprise executing programs 401a being the user interface, viewer and editor code for displaying information and responding to editor commands, 401b being the dataset search and manipulation code for searching and manipulating the datasets and, 401c being the external database and messaging code for managing and interacting with external utilities such as databases and messaging tools. A preferred method of implementation of the utilities is as a web server application code, the implementation of internal messaging using the datasets of notifications and requests, and the implementation of external messaging using standard email technology. The datasets 402 store all cooperative care information. For each participant access to information is governed by the permissions recorded in the permissions dataset 402a. Association relationships located at 402b link the participants in a network. Cooperative care plans located at 402c are associated with a participant details at 402d and in particular their needs and goals. Cooperative care actions 402e are associated with cooperative care plans 402c. Care relationships link associated participants 402d with cooperative care plans 402c and cooperative care actions. Care experiences located at 402f are recorded by care participants 402d for their cooperative care plans 402c, cooperative care actions 402e, and carers. Notifications and requests are generated by participants 402d and stored for each participant in the notifications and requests dataset 402g. A preferred method of implementation of the datasets is as tables in a relational database.

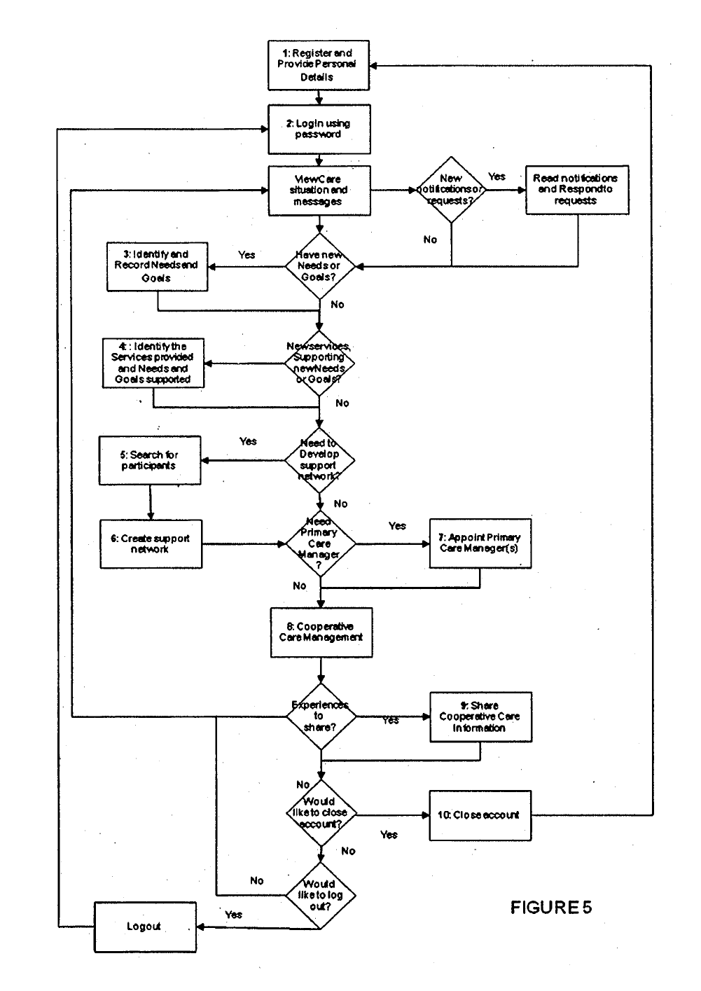

The flow chart of FIG. 5 illustrates an exemplary processing of a consumer centred cooperative care management system in accordance with a preferred embodiment of the present invention. In this process the functionality is used based on the changing circumstances of the participant. The details of each functionality are described below. The user of the system has a number of options in modifying the participant, care, and relationship, information. These modifications result in notifications and requests for other participants. Such notifications and requests then affect the circumstances of other participants which in turn modify the participant, care, and relationship, information available to them. This process continues as a consumer centred cooperative process. It is noted that not all aspects of each functionality are included in the diagram of FIG. 5. For example, removing a primary care manager is not included—this functionality will be used if the condition “Remove Primary Care Manager?” will hold.

In a preferred embodiment and with further reference to FIG. 5, the system for cooperative home base care includes the following functionality:
Functionality 1: Registration of personal details
Functionality 2: Login and Logout
Functionality 3: Recordal and removal of needs and goals for the consumer, being a person in need.
Functionality 4: Identification and removal of the services provided by participants and the needs and goals supported
Functionality 5: Searching for participants
Functionality 6: Creation and removal of relationship links between the participants to form networks
Functionality 7: Appointment of primary care managers
Functionality 8: Implementation of cooperative care management
Functionality 8.1: Learning from the experience of others (re needs and goals)
Functionality 8.2: Creating and removal of a cooperative care plan
Functionality 8.3: Appointing and removing a cooperative care plan manager
Functionality 8.4: Developing a cooperative care plan
Functionality 8.4.1: Learning from the experience of others (re needs and goals of the cooperative care plan)
Functionality 8.4.2: Adding and removing an action
Functionality 8.4.3: Scheduling an action
Functionality 8.4.4: Appointing and removing primary carers and co-carers
Functionality 8.5: Implementing the cooperative care plan
Functionality 8.6: Supporting cooperative implementation
Functionality 8.7: Viewing and updating cooperative care plans
Functionality 9: Sharing of cooperative care information
Functionality 9.1: Sharing cooperative care information
Functionality 9.2: Sharing experiences
Functionality 9.3: Sharing status information
Functionality 10: Closing an account

After Functionality 2 (login) a participant can perform one or more of Functionality 3 to 10 (including any sub-functionality). Unless there is functional, dependency, as described below, the functionality does not have to be performed in any particular order, The details of the functionalities listed above are as follows:

### Functionality 1: Registration of Personal Details

As indicated in action box 1 of FIG. 5, a participant in the system can open an account and provide their contact details, This information may be incorporated into a directory of participants as exemplified by component 402d in FIG. 4. Some of these details may be classified as private such that they cannot be viewed or matched by other participants. Initially only the name, country, status, and services provided are available to all other participants. Access to other information, including personal and care information, is controlled by the permissions set by the participant under Functionality 9. The access to participant's public and private information is described under Functionality 5 and Functionality 8. Some of the information may be recorded in an external database stored on one or more servers 303 of FIG. 3.

### Functionality 2: Login and Logout

Login to the system is indicated at action box 2 of FIG. 5 and may be carried out using any convenient security means. Typically login is achieved using a unique identifier and password. The system presents to the participant the list of existing participants and cooperative care plans and actions which they have permission to view. The system also presents requests from other participants to take on a particular role, to participate in a cooperative care plan, or to participate in an action. Access to and interaction with the system for the purpose of providing and retrieving information and controls can be through a range of electronic and non-electronic communication technology including, but not limited to, one or a combination of internet technology, mobile technology, telephony, etc. Once a participant has logged in to the system they can then logout and return to the initial login interface.

### Functionality 3: Recordal and Removal of Needs, Objectives and Goals for the Person in Need is Indicated at Action Box 3 of FIG. 5.

The needs, objectives and goals for the consumer can be many and varied, such as for example, relating to domestic care (e.g. domestic cleaning, physical care); mobility (e.g., transportation to a social activities), health care (e.g. improving cardio vascular system), mental care (e.g. avoiding depression), etc. These needs and goals et cetera can be entered into the system by the consumer or with the assistance of a participant who is a primary care manager'as defined in Functionality 7.

Using the editor 401a of FIG. 4 for the participant information the need or goal et cetera may be recorded directly or by selecting the need or goal from a list of needs and goals that have been previously identified by others. The list of previously identified needs and goals may be stored in the database as part of the dataset of previously defined needs and goals.

Once a need or goal is recorded the consumer may remove their need or goal by using the editor 401a for the participant information. A need or goal for a participant can only be removed if there are no cooperative care plans recorded for that participant which have that need or goal as their purpose.

As indicated at 401a of FIG. 4, a preferred method of implementation for the editor for the participant information includes a user interface which displays the participant information and code for retrieving a participant's record from the dataset, displaying the attributes of the record, amending the record attributes based on user input, and storing the amended record (and any dependant records) in the dataset. A preferred method of implementation for removing a need or goal is a remove button visually associated with the need or goal. The removal button can be used if there are no cooperative care plans recorded for that participant which have that need or goal as their purpose. All primary care managers and affected cooperative care plan managers, carers and co-carers are notified of any such changes.

Functionality 4: Recordal and Removal of the Services Provided by Participants and'the Needs and Goals et cetera Supported is Indicated at Action Box 4 of FIG. 5.

The participant can identify and record any services they provide and the needs, objectives and goals that they support. These services, needs and goals can be many and varied, such as for example, relating to domestic care (e.g. domestic cleaning, physical care), mobility (e.g., transportation to social activity), health care (e.g. improving cardio vascular system), mental care (e.g. avoiding depression), etc.

A service, need, or goal may be recorded directly or by selecting the service, need, or goal from a list of services, needs, and goals that have been previously identified by others. A participant that records the provision of services or support is referred to as a ‘service provider’. A consumer may also be a participant who is a service provider. Once a service, or need or goal supported, is recorded the participant may remove the service, or need or goal supported, by using the editor 401a for the participant information.

A preferred method of implementation of the editor 401a for the participant information includes a user interface which displays the participant information and code for retrieving a participant's record from the dataset, displaying the attributes of the record, amending the record attributes based on user input, and storing the amended record (and any dependant records) in the dataset. A preferred method of implementation for removing a service, or need or goal supported, is a remove button visually associated with the service, or need, or goal supported.

### Functionality 5: Searching for Participants is Indicated at Action Box 5 of FIG. 5 and May be Performed by the Dataset Search Tool 401b of FIG. 4.

A participant has recorded details (as mentioned in Functionality 1 and Functionality 3). Any participant may search for other participants, including service providers, which have details and services that match the person in need's details or other details specified ‘by the searching’ participant. A participant may specify a search for another participant based on any combination of public details (“search criteria”). These may include the name, location, email address, services provided, and description.

The automated system identifies all the participants with the matching. details as follows:

The details of each participant registered in the automated system are checked and the following matches are attempted:
(a) For any name specified:
   (a)(i) the exact name specified is matched to the exact name of the checked participant (“exact name match”)
   (a)(ii) all of the specified name is matched as a part of the name or part of the specified name is matched as all of the name or part of the specified name is matched as part of the name (“approximate name match”),
   (a)(iii) the quality of the match is determined by the extent of the words of the specified name that are found—the more of the specified name that is found the better the quality of the match.
(b) For any email address, full or partial, specified:
   (b)(i) the exact email address specified is matched to the exact email address of the checked participant (“exact email address match”)
   (b)(ii) all of the specified email address is matched as a part of the email address or part of the specified email address is matched as all of the email address or part of the specified email address is matched as part of the email address (“approximate email address match”),
   (b)(iii) the quality of the match is determined by the extent of the words of the specified email address that are found—the more of the specified email address that is found the better the quality of the match.
(c) For a location specified:
   (c)(i) the exact location is matched to the location of the checked participant (“exact location match”),
   (c)(ii) a location in the proximity of the specified location is found (“approximate location match”),
   (c)(iii) the quality of the match is determined by the proximity to the specified location—the closer the location the better the quality of the match.
(d) For needs, goals, or services provided specified:
   (d)(i) all of the needs, goals, and services provided specified are found as being supported by the checked participant (‘exact services match’),
   (d)(ii) some of the needs, goals, and services, provided specified are found (‘approximate services match’),
   (d)(iii)the quality of the match is determined by the number of needs, goals, and services provided specified that are found—the more that are found the better the quality of the match.
(e) For a description specified:
   (e)(i) all of the specified description is matched in the description of the checked participant (‘exact description match’)
   (e)(ii) all of the specified description is matched as a part of the description or part of the specified description is matched as all of the description or part of the specified description is matched as part of the description (‘approximate description match’),
   (e)(iii) the quality of the match is determined by the extent of the words and sentences of the specified description that are found—the more of the specified description that is found the better the quality of the match.

Similar matches may be specified for other details of the participant. The overall quality of the match for a checked participant is determined by the automated system based on the quality and number of exact and approximate matches.

The list of matched participants which have an exact or partial matches are provided by the automated system to the searching participant. This list of participants may include an indication of each matched participant that is already associated with the searching participant. The list can be ordered by the overall quality of the match.

A preferred method of implementation of the search tool 401b includes a user interface which displays text boxes for the search criteria and a list of participants that matched the criteria, and code for retrieving the search criteria as per the user input, searching through the dataset of participants, matching the attributes of each participant with the search criteria, and displaying the list of matched participants.

A button for adding a participant as an associate of the searching user is displayed beside each matched participant that is not an associate of the searching user. A button for removing a participant as an associate of the searching user is displayed beside each matched participant that is an associate of the searching user. See Functionality 6 for further details on creation and removal of relationship links between the participants.

### Functionality 6: Creation and Removal of Relationship Links Between the Participants to Form Networks is Indicated at Action Box 6 of FIG. 5

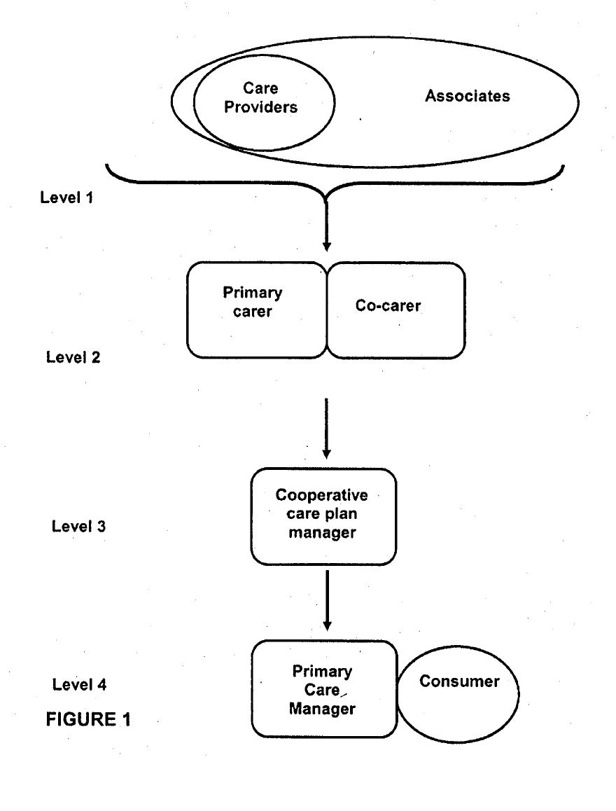

In the formation of a support network, ‘associates’ are friends, family or others who have an interest in the consumer but do not necessarily provide services. With reference to FIG. 1, this level of connection or responsibility corresponds to the first level of responsibility in the system, Level 1. As shown in FIG. 1, in addition to the first level, there may be a second level of responsibility comprising a primary carer and a co-carer (as mentioned at Functionality 8.4.4), Level 2. A third level of responsibility comprising a cooperative care plan manager (as mentioned at Functionality 8.3), Level 3 and a fourth and final level of responsibility comprising a primary. care manager (as mentioned at Functionality 7), Level 4. All associates with an assigned role or responsibility are referred to as ‘carers’ or ‘care providers’ of the consumer.

A participant can create links between groups of people to create a support network. For example, a network of associates or care providers can be created, with sub-networks for friends, medical practitioners, advisors or the like. Information about members can be shared between network members. Invitations to join the network can be sent to other participants and is not limited to those listed in the directory of participants.

A participant can simultaneously have the role of one or more of a consumer, a care provider, or an associate. The role adopted depends on the relationship with other participants and the responsibilities assumed by the participant.

A participant can have multiple other participants in their carers or associates network. A participant can be a carer or associate for multiple other participants. The carers or associates network can be developed and updated over multiple login sessions over a period of time.

The automated system records in the appropriate database the association relationships between all participants. In one embodiment establishing an association relationship takes the following steps:
(a) using Functionality 5 a participant (the ‘requesting participant’) searches and finds another participant (the ‘requested participant’) which the requesting participant would like to be associated with,
(b) if the ‘requested participant’ is not already associated with the requesting participant then, using the automated system the requesting participant sends an ‘association invitation’ to the requested participant,
   (b)(i) a tentative association relationship between the participants is recorded in the automated system database,
   (b)(ii) an electronic association invitation is sent to the ‘requested participant’ on behalf of the ‘requesting participant’ using the messaging means,
(c) upon receipt of the ‘association invitation’ the ‘requested participant’ may accept or reject the invitation using the automated system. The automated system records in the dataset of association relationships the decision.
   (c)(i) if the ‘requested participant’ accepts the invitation then the tentative association relationship is recorded as confirmed in the automated system database,
   (c)(ii) if the ‘requested participant’ rejects the invitation then the tentative association relationship is deleted from the automated system database,
(d) the ‘requesting participant’ is notified of the decision of the ‘requested participant’.

In a second embodiment of this relationship formation, establishing an association relationship takes the following steps:
(a) the ‘requesting participant’ can send an ‘association invitation’ to a specified email address representing a participant not already registered in the automated system,
(b) if the email address is of a participant already registered In the automated system then that participant is returned to the ‘requesting participant’ as if a search was performed using Functionality 5 with the specified email address. Establishing an association relationship continues as per step (b) of the first embodiment of establishing an association relationship.
(c) if the email address is of a participant not already registered in the automated system then, using the external messaging means the automated system sends on behalf of the requesting participant a ‘registration invitation’ email to the specified email address inviting the person-to register as a participant.
(d) upon receipt of the ‘registration invitation’ email the ‘requested participant’ can accept the invitation and register as a participant in the automated system as per Functionality 1.
(e) Once registered the person is a participant and establishing an association relationship can proceed as per the first embodiment of association relationship establishment noted above.

A preferred method of implementation of an association relationship is as a record in a table of friendship and care relationships within a relational database schematically illustrated as 402b in FIG. 4.

The association relationship implements the first level of responsibility and support network for a consumer as illustrated at level 1 of FIG. 1. With reference to FIG. 4, once an association relationship is recorded the participant may remove the relationship by using the editor utility 401a for the dataset of friendship and care relationship, eg 402b. A consumer can remove an association relationship with a participant only if that participant does have a coordination, management, or care responsibility in any of the cooperative care plans or care actions recorded for the consumer.

All primary care managers and affected cooperative care plan managers, carers and co-carers may be notified of any such changes.

A preferred method of implementation of the association relationship viewer and editor, eg 401a, includes a user interface which displays for each participant the list of names of associated participants and code for retrieving association relationships from the dataset 402b of friendship and care relationship links between participants, retrieving a participant's record from the dataset of participants, displaying the attributes of the participant, creating or removing relationship records based on user input, and storing the amended dataset (and any dependant records) in the database.

A preferred method of implementation for adding an association relationship is an add button visually associated with the name of a participant in the list of participants found in a search for participants as per Functionality 5.

A preferred method of implementation for removing an association relationship is a remove button visually associated with the name of the associated participant in the list of associated participants and the list of participants found in the a search for participants as per Functionality 5. Alternatively, there could be a number of other implementations for adding and/or removing associations as would be appreciated by the person skilled in the art.

### Functionality 7: Appointment and Removal of Primary Care Managers is Illustrated in Action Box 7 of FIG. 5.

Each consumer can manage their care as described in Functionality 8 below. The consumer can also request one or more of their carers or associates to be their ‘primary care manager’ as follows:
(a) If an associated participant is not already a primary care manager for a participant then, using the automated system, that participant (the ‘requesting participant’) can send to an associated participant (the ‘requested participant’) a ‘primary care manager invitation’,
   (a)(i) a tentative primary care management relationship between the participants, also identifying the association relationship, is recorded in the automated system database,
   (a)(ii) an electronic primary care management invitation is sent to the ‘requested participant’ on behalf of the ‘requesting participant’ using the messaging means,
(b) upon receipt of the ‘primary care management invitation’ the ‘requested participant’ may accept or reject the invitation using the automated system,
   (b)(i) if the ‘requested participant’ accepts the Invitation, using the tool for responding to requests, then the tentative primary care management relationship is recorded as confirmed in the automated system database,
   (b)(ii) if the ‘requested participant’ rejects the invitation, using the tool far responding to requests, then the tentative primary care management relationship is deleted from the automated system database,
(c) the ‘requesting participant’ is notified of the decision of the ‘requested participant’ using the internal messaging means

A preferred method of implementation of a dataset of notifications and requests is a table in a database where a notification includes the following attributes:
(a) the sending participant,
(b) on behalf of whom is it sent (if sent by a manager on behalf of a consumer)
(c) the recipient participant,
(d) the notification information sent, and
(e) the time and date the notification was sent.

A request may include the following attributes:
(a) the sending participant,
(b) on behalf of whom is it sent (if sent by a manager on behalf of a consumer)
(c) the recipient participant,
(d) the nature of the request, including the possible. responses (e.g., “accept” or “reject”), and
(e) the time and date the request was sent.

Notifications and requests are generated through the actions of the users in establishing care networks and specifying and managing the care. Such notifications and requests are stored in the dataset of notifications and requests as described above.

A preferred method of implementing and using internal messaging means includes:
(a) a user interface for displaying notifications and requests in the form of a list,
(b) code for: creating a record of notification or request based on user action, storing the notification or request in the dataset of notifications and requests, retrieving the list of notifications and requests for a specific user from the dataset of notification of requests, and displaying the list of notifications and requests.

A preferred method for implementing a utility or tool for responding to requests is a user interface that displays for each request the response options in the form of buttons located along side the request and labelled with the response (e.g., “accept” or “reject”), and code for displaying the response options and recording the response in the automated system database. The user interface of the tool for responding to requests could be integrated with the user interface of the internal messaging means.

A primary care manager for a consumer can manage the care, as described in Functionality 8 below, on behalf of the consumer. The automated system provides a participant with view and update permissions for the management of care of another participant based on the confirmed primary care management relationships recorded in the database. Each consumer may also become a primary care manager for their own care. Further, a participant can be a primary care manager for multiple people in need.

### Functionality 8: Implementation of Cooperative Care Management is Illustrated in Action Box 8 of FIG. 5

Before care can be provided to a person(s) in need one must determine how best to attend to their need and the overall approach to be taken for their care. This may include obtaining information about the care and action options available and the possible carers that could support an appropriate cooperative care plan. This process is likely to be iterative until a suitable plan is determined.

Each functionality associated with cooperative care management can be supported through dedicated group communication mechanisms such as discussion groups, blogs, twitters, for the relevant membership. Examples may include a discussion group of all the associates and carers of a consumer, discussion group of all the primary care managers of a consumer, a twitter group of all the carers that participate in a cooperative care plan, and other networks and communication groups created in support of the cooperative management of care.

Functionality 8.1: Learning from the Experience of Others (Re Needs and Goals)

A useful functionality relates to learning from the experience of others With respect to addressing the needs and goals of the consumer.

For the purpose of addressing the needs and goals of the consumer, the primary care managers (which can include the consumer), can search, retrieve, and view information and experiences that participants have provided on cooperative care plans and actions relevant to all or some of the identified needs and goals of the consumer. They can also view information and experiences that participants have contributed regarding other carers and their provision of care relevant to all or some of the identified needs and goals of the consumer. Any participant may search for ‘care experiences’ recorded by any participant using Functionality 9. This is done using the tools for searching, and viewing results of searching, the information stored in the dataset of participants and the datasets of care relationships as Illustrated by way of example in FIG. 4.

A participant may specify a search for care experiences based on any combination of care details. These may include the name and description of a cooperative care plan, name and description of a care action, the needs or goals addressed by a cooperative care plan, the name of and services provided by a primary carer, and the time of the provision of care.

The automated system preferably identifies all the care experiences with the matching details as follows:

The details of each care experience in the automated system are checked and the following matches are attempted:
(a) For any name of a cooperative care plan, care action, or primary carer specified:
   (a)(i) the exact name specified is matched to the exact name of the checked participant (‘exact name match’)
   (a)(ii) all of the specified name is matched as a part of the name or part of the specified name is matched as all of the name or part of the specified name is matched as part of the name (‘approximate name match’),
   (a)(iii) the quality of the match is determined by the extent of the words of the specified name that are found—the more of the specified name that is found the better the quality of the match.
(b) For needs, goals, or services provided or specified:
   (b)(i) all of the needs, goals, and services provided or specified are found as being supported by the checked participant (‘exact services match’),
   (b)(ii) some of the needs, goals, and services provided or specified are found (‘approximate services match’),
   (b)(iii) the quality of the match is determined by the number of needs, goals, and services provided or specified that are found—the more that are found the better the quality of the match.
(c) For a description specified:
   (c)(i) all of the specified description is matched in the description of the checked participant (‘exact description match’)
(c)(ii) all of the specified description is matched as a part of the description or part of the specified description is matched as all of the description or part of the specified description is matched as part of the description (‘approximate description match’),
   (c)(iii) the quality of the match is determined by the extent of the words and sentences of the specified description that are found—the more of the specified description that is found the better the quality of the match.
(d) For a time of provision of care specified:
   (d)(i) the exact time is matched to the time of the checked care experience (‘exact time match’),
   (d)(ii) a time in the proximity of the specified time is found (‘approximate time match’),
   (d)(iii) the quality of the match is determined by the proximity to the specified time—the closer the time the better the quality of the match.

Similar matches are specified for other details of the care experience. The overall quality of the match for a checked care experience is determined by the automated system based on the quality and number of exact and approximate matches.

The list of matched care experiences which have exact or partial matches are provided by the automated system to the searching participant. This list of care experiences may include an indication of the average rating provided by participants based on the care experiences, The list can be ordered by the overall quality of the match.

Learning from the experiences of others can, for example, be facilitated by electronically searching comments relating to a specific subject (e.g. a particular cooperative care plan, action, or carer), through discussion groups with the associates and carers and with other participants, through a diary or blog of participants, or other experience sharing mechanisms as per Functionality 8.6

### Functionality 8.2: Creating and Removing a Cooperative Care Plan

A cooperative care plan for a consumer is designed to address one or more needs and goals of that person. A primary care manager (who could be the consumer) identifies and creates a set of actions for incorporation into the cooperative care plan that will address a set of needs and goals of the consumer. The cooperative care plan is specified by the following attributes:
(a) a name,
(b) the consumer to which the cooperative care plan applies,
(c) one or more needs or goals, of the consumer, which are addressed by the plan,
(d) a description of the approach adopted and how it fits within the overall care approach,
(e) optional information includes:
   (e)(i) the names of the cooperative care plan managers,
   (e)(ii) the associates of the consumer which can view the cooperative care plan and,
   (e)(iii) incorporated care actions.

A preferred method of embodying a cooperative care plan is as a record in a table of cooperative care plans within a relational database such as cooperative care plan 402c illustrated in FIG. 4.

The cooperative care plan is created using the editor 401a for the cooperative care plans. This editor allows the primary care manager to provide the attributes of the cooperative care plan and then store the cooperative care plan in the database under dataset 402c. The editors 401a assist the user in filling in the attributes of the care plan as follows:
(a) for the selection of the consumer for which the cooperative care plan applies: using the dataset of primary care relationships the editor presents to the user the list of people for which the user is a primary carer (with the user himself being the default consumer). The selected consumer is recorded in the cooperative care plan,
(b) for the selection of the needs or goals addressed by the cooperative care plan: using the dataset for the participating consumer the editor presents to the user the needs and goals of the selected person, using a dataset of friendships between participants the editor presents to the user the list of associates for the selected person. The need or goal may be recorded directly, from the needs and goals of the selected consumer, or from the dataset of previously defined needs and goals. The selected needs and goals are recorded in the cooperative care plan. If these are new needs and goals then they are also recorded in the information on the consumer and the dataset of previously defined needs and goals,
(c) for the selection of the cooperative care plan managers: using a dataset of friendships between participants the editor presents to the user the list of associates for the selected person. The selected cooperative care plan managers are recorded in the dataset of permissions for the selected consumer and the cooperative care plan (see further details below),
(d) for the selection of associates which can view the cooperative care plan: using the dataset of friendships between participants the editor presents to the user the list of associates for the selected person. The selected viewers of the cooperative care plan are recorded in the dataset of permissions for the selected consumer and the cooperative care plan.

The automated system stores the cooperative care plan in a database such as 402c noted above. Such a database can be implemented, for example, using a relational database with a table for the attributes of the cooperative care plan. Other examples of suitable databases would be recognised by the person skilled in the art and, accordingly, are incorporated herein. The automated system provides the primary care manager with utilities for creating and editing cooperative care plans for the consumer. A cooperative care plan can address one or more needs and goals. A need or goal may be addressed by multiple cooperative care plans. The utilities and editors for the cooperative care plans are implemented as user interfaces that allow the user to create a care plan, view a care plan, edit a care plan, and delete a care plan.

A preferred method of implementation of a cooperative care plan editor such as 401a illustrated in FIG. 4 includes a form based user interface with text boxes and where limited option selection is implemented using drop down lists, and code for retrieving the relevant information for the datasets as specified above, displaying the information in the text boxes and lists, amending the cooperative care plan attributes, and storing the amended cooperative care plan in a table of cooperative care plans stored in the automated system database, for example that of 402c in FIG. 4.

Once a cooperative care plan is recorded the primary care manager may remove the cooperative care plan by using the cooperative care plan editor. Removing the cooperative care plan will also remove all the cooperative care actions 402e which are part of the removed cooperative care plan and amend the permissions dataset 402a accordingly.

All primary care managers and affected cooperative care plan managers, carers and co-carers are notified of these changes.

### Functionality 8.3: Appointing and Removing a Cooperative Care Plan Manager

A primary care manager, who could be the consumer, can manage each cooperative care plan as described in Functionalities 8.4 to 8.7 below. A primary care manager can also request one or more of the associates and carers of the consumer as cooperative care plan manager(s) for each cooperative care plan for the consumer as follows:
(a) If an associated participant is not already a cooperative care plan manager for an ‘identified cooperative care plan’ then, using the automated system as described above, the primary care manager (the ‘requesting participant’) can select a cooperative care plan manager. On behalf of the ‘requesting participant’ and using the messaging means, the automated system sends to the associate (the ‘requested participant’) a ‘cooperative care plan manager invitation’ which includes the details of the identified cooperative care plan,
   (a)(i) a tentative cooperative care plan management relationship between the ‘requested participant’ and the ‘identified cooperative care plan’, also identifying the association relationship, is recorded in the automated system database,
   (a)(ii) an electronic cooperative care plan management invitation is sent to the ‘requested participant’
(b) upon receipt of the ‘cooperative care plan management invitation’ the ‘requested participant’ may, using the tool for responding to requests, accept or reject the invitation using the automated system,
   (b)(i) if the ‘requested participant’ accepts the invitation then the tentative cooperative care plan management relationship is recorded as confirmed in the automated system database,
   (b)(ii) if the ‘requested participant’ rejects the invitation then the tentative cooperative care plan management relationship is deleted from the automated system database,
(c) the ‘requesting participant’ is notified, using the messaging means, of the decision of the ‘requested participant’.

A cooperative care plan manager for a cooperative care plan can manage that plan, as described in Functionalities 8.4 to 8.7 below, on behalf of the consumer. Thus, a primary care manager for a consumer is also a cooperative care plan manager for all the cooperative care plans of that consumer. The automated system provides a participant with view and update permissions for the cooperative care plan management of the identified cooperative care plan based on the confirmed cooperative care plan management relationships recorded in the database. Based on the process of creating and editing cooperative care plans, as described above, the dataset of permissions stores the management and view permissions for each cooperative care plan. A permission to view a plan includes a permission to view all actions included in the plan. When the automated system displays the plans, and their included actions, for an associate of a participant it uses the dataset of permissions for that associate to determine which of their cooperative care plans can be viewed by the participant and which can be edited by the participant. Subject to these permissions the participant can use the cooperative care plan viewer or editor accordingly. By default the permission to view a cooperative care plan for a specific consumer also creates a permission to view the needs and goals of that consumer which is addressed by that cooperative care plan.

A participant can be a cooperative care plan manager for multiple cooperative care plans for multiple people in need.

Once a cooperative care plan manager is recorded the primary care manager may remove the cooperative care plan manager by using the cooperative care plan editor. Removing the cooperative care plan manager will also amend the permissions dataset 402a accordingly.

All primary care managers and affected cooperative care plan managers, carers and co-carers are notified of any appointments and removals.

### Functionality 8.4: Developing the Cooperative Care Plan

The cooperative care plan includes a set of actions that are performed in a particular order by one or more carers. The cooperative care plan manager, which could be the consumer, can learn from the experience of others in addressing the relevant needs and goals, determines the required actions, and appoints the carers that will be responsible for implementing each action.

Functionality 8.4.1: Learning from the Experience of Others (Re Needs and Goals of the Cooperative Care Plan

For the purpose of developing a cooperative care plan, the cooperative care plan managers, (who can include the consumer) can search, retrieve, and view information and experiences that participants have provided on cooperative care plans and actions relevant to all or some of the needs and goals that the specific cooperative care plan is addressing.

They can also view information and experiences that participants have provided on other carers and their provision of care relevant to all or some of the needs and goals that the specific cooperative care plan is addressing.

Learning from the experiences of others can for example, be facilitated by searching electronic comments relating to a specific subject (i.e., a particular cooperative care plan, action, or carer), through discussion groups with the associates and carers and with other participants, through a diary or blog of participants, or other experience sharing mechanisms. The method of implementation is similar to that described for Functionality 8A.

### Functionality 8.4.2: Adding and Removing an Action

An action is an activity (such as medication dosage) or any other task included in the cooperative care plan. It may be performed by one carer or two or more carers, one of whom may be the consumer. An action can have a single occurrence or recurrence at desired or requisite intervals. The cooperative care plan manager can identify any-appropriate actions suitable for the consumer, the needs and goals of the relevant cooperative care plan, the available carers, and other relevant circumstances. A care action Is specified by the following attributes:
(a) a name,
(b) the cooperative care plan to which the care action is part of,
(c) the consumer for which the selected cooperative care plan applies,
(d) the status of the action, being pending, approved, or rejected by the carers
(e) a description of the action,
(f) Care delivery information includes:
   (f)(i) the names of the primary carers,
   (f)(ii) the names of the co-carers,
   (f)(iii) location
   (f)(iv) scheduling information including start time, duration and/or end time, and any recurrence
(g) Care type information such as: medication, exercise, property maintenance, transport, housework, mobility, meal preparation, etc. A preferred method of implementation of a cooperative care action is as a record in a table of care actions within a relational database, for example, as illustrated at 402e of FIG. 4.

With reference to FIG. 4, the care action is created using the editor 401a for the care actions. This editor 401a allows the cooperative care plan manager to provide the attributes of the care action and then store the care action in a database 402e. The editors 401a assist the user in filling in the attributes of the care action as follows:
(a) for the selection of the consumer for which the care action applies: using the dataset of primary care relationships the editor presents to the user the list of people for which the user is a cooperative care plan manager (with the user himself being the default consumer),
(b) for the selection of the cooperative care plan which the action is part of: using the dataset for the cooperative care plans far the selected consumer the editor presents to the user the cooperative care plans In the dataset.
   Note: The user may first select the cooperative care plan, from the list of plans they manage. In this case the consumer will be set to the person identified in the selected cooperative care plan.
(c) for the selection of the primary carers and co-carers: using a dataset of friendships between participants the editor presents to the user the list of associates for the selected consumer. The selected primary carers and co-carers for the action are recorded in the care action (see further details below),
(d) for the selection of action types: using a dataset of previously defined action types the editor presents to the user the list of action types. The action type may be recorded directly or by selecting the action type from a list of previously defined action types. The selected action type is recorded in the action and if new in the dataset of previously selected action types.

The automated system stores the care action in a database and records the action in the record of the selected cooperative care plan. Such a database can be implemented using a relational database with a table for the attributes of the care action. Other examples of suitable databases would be recognised by the person skilled in the art and, accordingly, are incorporated herein.

A preferred method of implementation of a cooperative care action editor includes a form based user interface with text boxes and where limited option selection is implemented using drop down lists, and code for retrieving the relevant information for the datasets as specified above, displaying the information in the text boxes and lists, amending the cooperative care action attributes, and storing the amended cooperative care action in a table of cooperative care action stored in the automated system database.

Once a cooperative care action is recorded the cooperative care plan manager may remove the cooperative care action by using the cooperative care action editor. Removing the cooperative care action will also amend the permissions dataset 402a accordingly.

All affected cooperative care plan managers, carers and co-carers are notified of any adding and removals of care actions.

### Functionality 8.4.3: Scheduling an Action

The cooperative care plan manager can determine the time, duration, recurrence, and location of the implementation of an action. In preferred embodiments, it is envisaged that the automated system allows for multiple ways of scheduling an action. One way is inputting the scheduling information using a form based interface. Another way of inputting the scheduling information is using a calendar based interface. A third way is using a timeline based interface. Using the calendar and timeline the user can select the start time, duration and/or end time.

A preferred method of implementing this functionality is using a distributed database driven scheduler system where appointments are appropriately modified to include care, carer, and permission information for each cooperative care action. Example implementations include DevExpress™ ASPxScheduler Suite™.

### Functionality 8.4.4: Appoint and Remove Primary Carers and Co-Carers

An action requires one or more primary carers and optionally one or more co-carers. For a given action the primary carer of that action has the primary responsibility for performing that action. The co-carers are required carers for the performance of that action.

The primary care plan manager can request the appointment of an associate and care provider as a primary carer or co-carer for the action. The consumer can be appointed as a primary carer or co-carer for an action as follows:
(a) If an associated participant is not already a primary carer or co-carer for an ‘identified care action’ within an ‘identified cooperative care plan’ then, using the automated system, the cooperative care plan manager for the identified cooperative care plan (the ‘requesting participant’) can send to an associated participant of the consumer (the ‘requested participant’) a ‘care action invitation’ which includes the details of the identified cooperative care plan, the details of the identified care action, and the requested role (being ‘primary carer’ or ‘co-carer’),
(a)(i) a tentative carer relationship, identified as primary carer or co-carer, between the ‘requested participant’ and the ‘identified care action’, also identifying the cooperative care plan and the association relationship, is recorded in the automated system database,
(a)(ii) an electronic care action invitation is sent to the ‘requested participant’ on behalf of the ‘requesting participant’ using the messaging means,
(b) upon receipt of the ‘care action invitation’ the ‘requested participant’ may accept or reject the invitation using the automated system,
   (b)(i) if the ‘requested participant’ accepts the invitation, using the tool for responding to requests, then
   (b)(i)(1) the tentative carer relationship for the identified care action and care role is recorded as confirmed in the automated system database,
   (b)(i)(2) if all other requested carers for this care have accepted their invitation then the status of the care action is recorded as confirmed in the automated system database,
   (b)(ii) if the ‘requested participant’ rejects the invitation, using the tool for responding to requests, then
   (b)(ii)(1) the tentative carer relationship for the identified care action and care role is recorded as rejected' in the automated system database,
   (b)(iii)(2) the status of the care action is recorded as rejected in the automated system database,
(c) the ‘requesting participant’ is notified, using the messaging means, of the decision of the ‘requested participant’.

A cooperative care action can be implemented if all the primary carers and co-carers have accepted their respective responsibility and participation in the action. The automated system provides a participant with view and update permissions for the identified care action based on the confirmed carer relationships recorded in the database.

Each appointed carer also has view and update permissions for the action they are participating in. These permissions are recorded In the permissions dataset 402a, When appointing a primary carer or co-carer for an action the cooperative care plan manager can determine the view permissions for each carer for the plan which includes the created or edited action. The default is to allow all carers to view the cooperative care plan. A permission to view a plan includes a permission to view all actions Included in the plan. These view permissions are also recorded in the permissions dataset 402a.

Based on the process of creating and editing cooperative care actions, as described above, the dataset of permissions stores the view and update permissions for each cooperative care plan and action. When the automated system displays the plans, and their included actions, for an associate of a participant it uses the dataset of permissions 402a for that associates to determine which of their cooperative care plans and actions can be viewed by the participant and which can be edited by the participant. Subject to these permissions the participant can use the cooperative care plan viewer or editor 401a accordingly.

A participant can be a primary carer and co-carer for multiple actions for multiple people in need.

Once a primary carer and co-carer are recorded the cooperative care plan manager may remove them by using the cooperative care action editor. Removing a primary carer or co-carer will also amend the permissions dataset 402a accordingly.

All affected cooperative care plan managers, carers and co-carers are notified of any appointments and removals.

Functionalities 8.4.1 to 8.4.4 can be repeated until the entire cooperative care plan has been developed. The cooperative care plan can be developed and updated over multiple login sessions over a period of time.

### Functionality 8.5: Implementing a Cooperative Care Plan

Implementing a cooperative care plan requires the implementation of each of the cooperative care actions within that plan. The implementation of a cooperative care action is performed jointly by the appointed primary carers and co-carers and the agreed place and time.

### Functionality 8.6: Supporting Cooperative Implementation

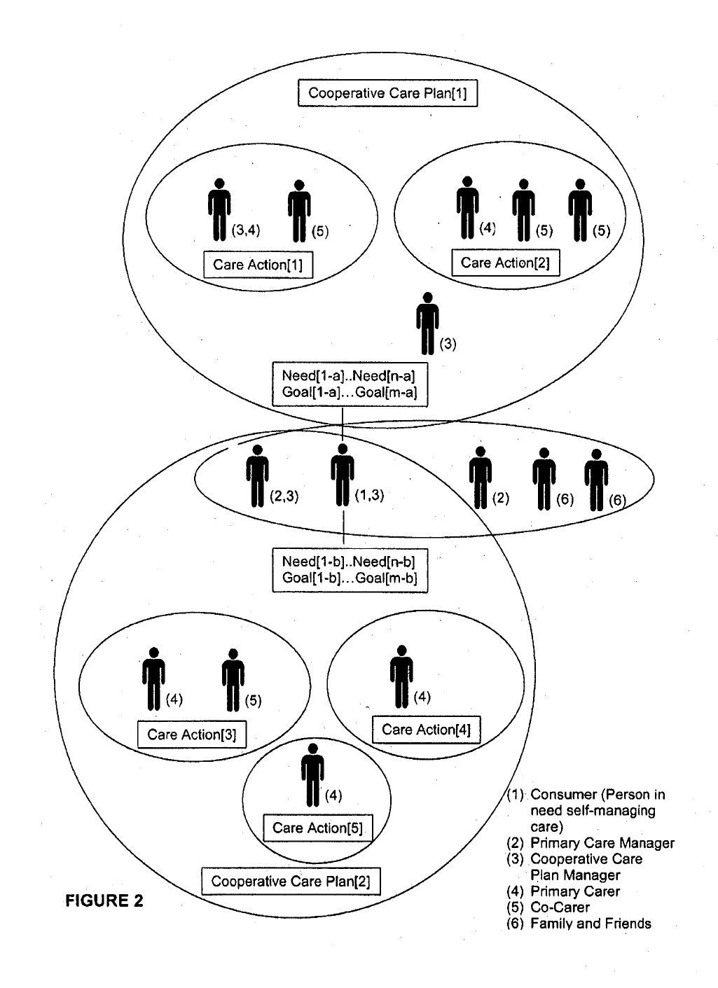

The automated system supports cooperative Implementation of care while preserving control of information dissemination. Access to care information is controlled through permissions. The approach to care is naturally structured through establishment of care relationships and the provision of care under a specific cooperative care plan or care action. This structure forms the basis for the ‘circles of care’ as depicted in FIG. 2. A ‘circle of care’ is a group of people cooperating to deliver a particular aspect of care to a consumer. The automated system provides utilities that support the cooperation between members of such a circle of care. Such utilities are referred to as ‘cooperation utilities’. The cooperation utilities are group communication mechanisms with access limited to members of a specific member of a circle of care. Example implementations of cooperation utilities include: limited access Internet forum, message board, or discussion forums, newsgroup or electronic mailing list, SMS based forum, teleconferencing and video conferencing tools, etc.

Upon request by a member of a circle of care the automated system creates a cooperation utility with limited and controlled membership as follows:
(a) for each participant a cooperation utility with membership of all participants associated with that participant,
(b) for each participant a cooperation utility with membership of all primary care managers of that participant,
(c) for each participant a cooperation utility with membership of all carers of that participant,
(d) for each cooperative care plan a cooperation utility with membership of all cooperative care plan managers of that cooperative care plan,
(e) for each cooperative care plan a cooperation utility with membership of all carers associated with that cooperative care plan,
(f) for each need or goal identified in the system a cooperation utility for all participants that have this need or goal or who are primary care managers for such participants,
(g) for each service provided identified in the system a cooperation utility for all participants that provide such a service.

When such a cooperation utility is established it is made available for access and use by the relevant participants. Each participant that is permitted to join such a utility, as per membership in the groups identified above, can elect to join the cooperation utility and use it to share experiences, discuss issues, exchange information, and coordinate activities, with other members of that group. Cooperation utilities for other care groups can be established manually.

### Functionality 8.7: Viewing and Updating Cooperative Care Plans

A participant can view and update their cooperative care plans using the viewers and editors 401a for the cooperative care plans 402c and care actions 402e. The primary purpose of the viewers and editors is to support the participant in managing their care. This includes viewing the attributes of the cooperative care plans, considering the suitability of the cooperative care plan and care actions given changing circumstances, availability of carers, and the passage of time, and then updating the cooperative care plans to better match the needs and goals of the participant. Subject to appropriate permissions a participant can view and update the cooperative care plans, and associated actions, of other participants.

The user interfaces that support the viewing and updating of care information, including cooperative care plans and care actions, can be implemented as a computer application running on a personal computer or terminal, a mobile or smart phone application running on a mobile or smart phone device, a web based service, website, or a web based application accessed through a web browser or as an add-in to a web browser, or a combination thereof. The consumer or their primary care managers can modify the permissions dataset 402a and allow some or all of the associates and carers to view some or all of the cooperative care plans of that consumer. This includes viewing some or all of the cooperative care plans and related actions. For each cooperative care plan and action some or all aspects could be made available for viewing by some or all of the associates and carers. Permissions are set when cooperative care plans and care actions are created or edited as described above. The primary care managers can also use the tool for managing permissions to directly modify the view and update permissions for the cooperative care plans and care actions. The consumer can also use the tool for managing permissions to appoint or remove the primary care managers. The preferred method of implementation of a permissions editor is described in Functionality 9.1.

Updating a cooperative care plan includes the ability to update all aspects of the plan including updating each of the actions and the assignment of responsibilities. A consumer and their primary care managers can update the cooperative care plans. For a given cooperative care plan the relevant cooperative care plan managers can update the details of that cooperative care plan.

Updates to a cooperative care plan or care action are identical to the process of creating except that existing information is already displayed to the user. In accordance with the processes described to create cooperative care plans and care actions, changes may require the acceptance of none, some, or all of: the consumer, some or all of the primary care managers, some or all of the cooperative care plan managers, and some or all of the affected primary carers and co-carers.

None, some, or all of: the consumer, primary care managers, cooperative plan managers, primary carers and co-carers, and the associates and carers, may be notified of the updates to a cooperative care plan. This is implemented using the messaging means similar to the requests and notifications generated when the cooperative care plans and care actions are created.

### Functionality 9: Sharing Cooperative Care Information is Illustrated in Action Box 9 of FIG. 5.

A consumer or their primary care managers can share information about the care and experiences with other participants. This is to allow associates and carers of the consumer to be informed of the care and in support of the above Functionality—including, Functionalities 6, 8.1, and 8.4.1.

Permissions are set when cooperative care plans and care actions are created or edited as described above. The primary care managers can also use the tool 401 for managing permissions to directly modify the view and update permissions for the cooperative care plans and care actions. The consumer can also use the tool for managing permissions to appoint or remove the primary care managers.

### Functionality 9.1.: Sharing Cooperative Care Information

The consumer or their primary care managers can allow some or all of the associates and carers to view some or all of the cooperative care plans of that consumer. For each cooperative care plan and action some or all aspects could be made available for viewing by some or all of the associates and carers. This allows the relevant associates and carers, by their family members or professional carers, to be informed of the care provided to the consumer.

The sharing of information on the care can be determined by specifying levels of access or access permissions for the information and possible participants that can access this information (including associates and carers). Setting on the level of access can be done on the specific care information, on the specific participant, or centrally in an overall information access and permissions database.

As described above basic view and update permissions are implemented by the automated system based on the primary care management, cooperative care plan management, and carer relationships. When the automated system displays in the viewers the plans, and their included actions, for an associate of a participant it uses the dataset of permissions 402a for, that associate to determine which of their cooperative care plans, care actions, and needs and goals, can be viewed by the participant and which cooperative care plans and care actions can be edited and updated by the participant. Subject to these permissions the participant can use the viewers or editors accordingly.

The automated system also provides the consumer and their primary care managers with utilities for allowing associates of the consumer to view any of the needs and goals, any of the cooperative care plans, and any of the care actions. Such user interfaces can be implemented as a computer application running on a personal computer or terminal, a mobile or smart phone application running on a mobile or smart phone device, a web based service, website, or a web based application accessed through a web browser or as an add-in to a web browser, or a combination thereof. The view of cooperative care plan and a specific care action can be implemented in a number of ways including a text based representation of the information, a form based representation with attributes and their specific values, in a calendar based representation, in a timeline representations, etc.

The automated system records in its database ‘View permission’ for any of the above care information for a specific associate or for all associates as follows:
(a) the view permission for a specific care action including the name, description, time, and associated carers.
(b) The view permission for a specific cooperative care plan in one of the following configuration:
   (b)(i) the cooperative care plan name, needs and goals addressed, description, and cooperative care plan managers,
   (b)(ii) above and view permissions for all the care actions included in the cooperative care plan as per (a) above,
(c) The view permission for a specific need or goal in one of the following configuration:
   (c)(i) the need or goal name
   (c)(ii) above and view permissions for all the cooperative care plans that address the need or goal as per (b) above,

The view permissions include an identification of the association relationships to ensure that only associates are permitted to view care information. For each participant the view permissions stored in the automated system database are used to control the display of care information about other participants they are associated with.

A preferred method of implementation of the utilities for managing permissions is an editor with a table of permissions. The rows of the table include the relevant associates and the carers with the columns for the information to be accessed. Each cell in the table identifies the level of permission afforded, i.e., none, view, update. A user can modify the permissions by modifying the values in the cells. The system then stores the updated permissions in the permissions dataset and uses that information to control access by participants to that information.

A special column is included representing the permissions for a primary care manager. This column provides for the permission for an associate to update all information, including most of the permissions dataset itself. However, the primary care manager permission can only be modified by the consumer.

Permissions editor that includes all permissions can be accessible from the participant information editor. In addition, a permissions editor which includes only relevant columns can be included in other editors, e.g., a permissions editor for accessing a cooperative care plan, with only a column for that cooperative care plan, can be included in the cooperative care plan editor.

### Functionality 9.2: Sharing Experiences

Once the cooperative care plan or cooperative care actions have been jointly implemented by the primary carers and co-carers under the management of the cooperative care plan managers, a consumer or their primary care managers can provide comments, reviews, and ratings on a particular cooperative care plan, action, or carer, in the context of the needs and goals that they have been designed to address.

Sharing of experiences can be through the publication of comments with respect to a specific subject (i.e., a particular cooperative care plan, action, or carer), through discussion groups with the associates and carers and with other participants, through a diary or blog of the consumer, or other experience sharing mechanisms.

A ‘care experience’ is identified as a comment and/or rating in numerical form (e.g., 1 to 10) or descriptive form (e.g., poor, good, very good, etc.) associated with a care activity (e.g., cooperative care plan or care action) or with a service provider.

In addition to the comment and rating, the care experience for a care action includes the name of the action, the time of implementation, the needs or goals addressed by the respective cooperative care plan, the care action description, and the name of the participant that provided the experience.

In addition to the comment and rating, the care experience for a care plan includes the name of the plan, the time of implementation, the needs or goals addressed, the care action description, and the name of the participant that provided the experience.

In addition to the comment and rating, the, care experience for a service provider includes the name of the service provider, the time of care provision, the needs or goals addressed, the role they filled, and the name of the participant that provided the experience.

A dedicated method for recording and storing care experiences, see 402f depicted in FIG. 4, is provided by the automated system as follows:
(a) Once a care action is implemented the consumer which is the recipient of the care, or their primary care managers, can record a care experience for the care action,
(b) Once a care action is implemented the consumer which is the recipient of the care, or their primary care managers, can record a care experience for the primary carers or co-carers of the action,
(c) Once a cooperative care plan is implemented the consumer which is the recipient of the care; or their primary care managers, can record a care experience for the cooperative care plan,
(d) Once a cooperative care plan is implemented the consumer which is the recipient of the care, or their primary care managers, can record a care experience for the cooperative care plan managers.

The care experiences are stored in the dataset of experiences and reviews 402f. The dataset 402f can be implemented as a relational database with attributes of the care experiences and reviews stored-in a table. The attributes of, the experience include:
(a) the reviewer,
(b) the subject of the experience and review, that is, the carer, cooperative care plan, or a care action,
(c) the date and time of the review,
(d) the rating: providing an assessment of the reviewer of (1) the suitability of the plan or action to the need or goal their were designed to address; or (2) the quality of the care delivered by a carer. The rating can be implemented as a numerical rating (e.g., 1 to 10) or value rating (e.g., very bad to very good)
(e) the experience: a description of the experience of the reviewer in respect of (1) the suitability of the plan or action to the need or goal their were designed to address; or (2) the quality of the care delivered by a carer.

The care experiences stored in the automated system can be used by other participants and deciding on the care approach as per Functionality 8.1 and 8.4.1.

### Functionality 9.3: Sharing Status Information

A participant's status information is publically available and can be used to share the current status with other participants. A participant can update their status by providing a description of their current conditions, feelings, activities, etc. The implementation of the status can be as a text box, blog, or external document. The user interface includes a tool for updating the status information. The user can specify if the status information should be sent, using the messaging means, to their primary care managers, cooperative care plan managers, all carers, or all associates, or a combination there of.

### Functionality 10: Closing an Account is Illustrated at Action Box 10 of FIG. 5.

A participant may close their account using the editor for participant information dataset. An account can only be closed after all cooperative care plans and association relationships are removed. The automated system facilitates the automated removal of cooperative care plans and association relationships. However, before an account can be closed a participant that has a care responsibility in the care of others (i.e., as a primary care manager or in their cooperative care plans) must first request and implement the removal of that responsibility. All primary care managers and affected cooperative care plan managers, carers and co-carers are notified of any removals.

Various embodiments of the invention may be embodied in many different forms, including computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, complier, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g.; PALASM, ABEL, or CUPL). Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device: The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

It should also be noted that where a flowchart is used herein to demonstrate various aspects of the invention, it should not be construed to limit the present Invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

“Comprises/comprising” and “includes/including” when used in this. specification is taken to specify the presence of stated features, integers, steps or components but does not preclude the Presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

I claim:

1. A method for self-managed consumer centred cooperative care comprising the steps of:
(a) the consumer or a primary care manager registering consumer characteristics,
(b) the consumer or the primary care manager creating at least one cooperative care plan for addressing at least one of the needs and objectives of the consumer,
(c) the consumer or the primary care manager or a cooperative care plan manager creating at least one action for the at least one cooperative care plan,
(d) the consumer or the primary care manager registering information for one or more other participants having roles chosen from the group comprising at least one of, care providers,
(ii) associates of the consumer,
(iii) co-carer,
(iv) primary care manager,
(v) cooperative care plan manager,
or combinations thereof,
(e) the consumer, primary care manager appointed by the consumer, or the cooperative care plan manager appointed by the consumer or primary care manager, allocating at least one of the actions to one or more respective participants for implementation of the cooperative care plan, and
(f) the consumer or the primary care manager appointed by the consumer, assigning permissions to the participants based on their role and any allocated actions,
wherein steps (a) to (f) are automated.

2. A method as claimed in claim 1 wherein the registered characteristics comprise at least one need or objective of the consumer.

3. A method as claimed in claim 1 wherein the permissions assigned relate to one or a combination of:
access to and modification of needs and care information;
ability to information share and communicate with other participants;
ability to create cooperative care plans;
ability to be involved in the actions comprised in the cooperative care plans.

4. A method as claimed in claim 3 wherein the permissions relating to communication are used to facilitate the formation of networks between participants having a point of commonality.

5. A method as claimed in claim 4 wherein the point of commonality between participants comprises one or a combination of:
their role;
a common action;
a common plan;
a common need or desire for information.

6. A method as claimed in claim 1 further comprising the step of designating at least one person to the role of one of:
(i) care provider,
(ii) associate of the consumer,
(iii) co-carer,
(iv) primary care manager,
(v) cooperative care plan manager

7. A method as claimed in claim 6 wherein the primary care managers are chosen by the consumer from one of:
the care providers;
associates, or;
the consumer.

8. A method as claimed in claim 6 wherein cooperative care plan managers are chosen by the consumer or a primary care manager from one of:
the care providers or;
the consumer.

9. A method as claimed in claim 1 wherein the role of primary care manager, appointed by the consumer, is to manage and coordinate the overall care provided to the consumer.

10. A method as claimed in claim 1 wherein the role of cooperative care plan manager, appointed by the consumer or appointed care manager, is to coordinate the development and implementation of the cooperative care plan and to ensure that all actions and activities relating to the cooperative care plan are carried out.

11. A method as claimed in any one of the preceding claims claim 1 further comprising the step of:
allocating to each action a person in the role of primary carer.

12. A method as claimed in claim 11 further comprising the step of:
allocating to each action a person in the role of co-carer.

13. A method as claimed in claim 12 wherein the allocated persons have responsibility for ensuring an action is carried out.

14. (canceled)

15. A method as claimed in further comprising one or a combination of the following steps for one or all of steps (a) to (f):
updating;
removing;
deregistering.

16. A method as claimed in claim 1 further comprising the step of:
providing information stored in a first database relating to the cooperative care plan of a first consumer to a second database for storing information relating to the cooperative care plan of a second consumer.

17. A method as claimed in claim 1 wherein the consumer of care is the sole participant and is allocated one or a combination of the roles.

18. A computer implemented system for consumer centred cooperative care comprising;
(a) first registration means for registering characteristics associated with a consumer in a first database,
(b) first automated creation means for creating at least one or more cooperative care plans designed to address one or more of the needs and objectives of the consumer,
(c) second automated creation means for creating one or more actions for one or more of the cooperative care plans,
(d) second registration means for registering information in a second database for one or more other participants having roles chosen from the group comprising, care providers,
(ii) associates of the consumer,
(iii) co-carer,
(iv) primary care manager,
(v) cooperative care plan manager,
or combinations thereof,
(e) allocation means for allocating at least one of the actions to one or more respective participants for implementation of the cooperative care plan, and
(f) assigning means for assigning permissions to the consumer and to the other participants based on their role and any allocated actions,
(g) messaging means for sending notifications and requests between participants, wherein steps (a) to (f) are automated.

19. A system as claimed in claim 18 further comprising additional processing means for one or more of:
updating networks of participants, roles, care plans, actions, allocations of actions, or assignment of permissions;
removing characteristics, care plans, actions, registered information for one or more other participants, allocations of actions, or assignments of permissions;
deregistering characteristics, or registered information for one or more other participants.

20. A system for cooperative care, the system comprising;
(A) a central server, and
(B) one or more remote terminals,
wherein the server
(a) receives characteristics for a participating consumer for registration in a database record including one or more cooperative care plans comprising one or more actions,
(b) receives information for registration in a database record for one or more participants having roles chosen from the group comprising, care provider,
(ii) associates of the consumer,
(iii) co-carer,
(iv) primary care manager,
(v) cooperative care plan manager,
or combinations thereof,
(c) receives information regarding allocation of one or more participants to the role of primary care manager for a consumer,
(d) receives information regarding the allocation of one or more participants to the role of cooperative care plan manager for a cooperative care plan,
(e) receives information regarding allocation of one or more actions to one or more respective participants for implementation of the cooperative care plan, and
(f) receives information regarding assignment of permissions to the consumer and to the other participants based on their roles and any allocated actions.

21. A system as claimed in claim 20 further comprising:
(AA) a local distribution server, wherein the local distribution server,
(i) performs identical functions to the central server for records pertaining to one or more consumers, and
(ii) forwards records for a consumer or participants to the central server;
(BB) a remote terminal adapted for monitoring and communicating cooperative care information with the local distribution server for one or more participants.

22. A system as claimed in claim 21 wherein one or more of the central server and the local distribution server further comprises one or more of:
update means for updating received characteristics or information;
removal means for removing received characteristics or information;
deregistration means for deregistering received characteristics or information.

23. (canceled)

24. A system as claimed in claim 20 further comprising:
(g) at least one remote terminal adapted for communicating updated characteristics, information, allocation of roles, allocation of actions or assignment of permissions;
(h) at least one remote terminal adapted for communicating instructions for removal of characteristics, information, allocation of roles, allocation of actions or assignment of permissions;
(i) at least one remote terminal adapted for communicating instructions to deregister characteristics or information.

25. A system as claimed in claim 18 wherein the consumer is the sole participant and is allocated one or a combination of the roles.

26. An apparatus adapted to automate consumer centred cooperative care said apparatus including:
processor means adapted to operate in accordance with a predetermined instruction set, said apparatus, in conjunction with said instruction set, being adapted to perform the method steps as claimed in steps (a) to (f) of claim 1.

27. (canceled)

28. (canceled)
